(19) United States
(12) Patent Application Publication
(10) Pub. No.: US 2010/0012647 A1
(43) Pub. Date: Jan. 21, 2010

(54) Operating Device For A Stove Top and Arrangement Of A Stove Top Having Such An Operating Device

(75) Inventors: Martin Baier, Ettlingen (DE); Wolfgang Alfred Hamm, Bretten (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O Elektro-Geräetebau GmbH

(21) Appl. No.: 12/557,755

(22) Filed: Sep. 11, 2009

Related U.S. Application Data
(63) Continuation of application No. PCT/EP2008/001724, filed on Mar. 5, 2008.

(30) Foreign Application Priority Data
Mar. 16, 2007 (DE) 10 2007 014 273.2
Mar. 27, 2007 (DE) 10 2007 016 466.3

(51) Int. Cl. H05B 1/02

(52) U.S. Cl. 219/482

(57) ABSTRACT

The invention relates to an operating device for a stove top, the device comprising rotary operating parts that are rotatably mounted in a base. The parts have a protruding region as a signal means, the region rotating in a plane of the stove top or a stove top plate when the rotary operating part rotates. In said plane, the stove top has a distance sensor, which can detect the rotation of the protruding region by means of the variable distance and evaluate the same as a rotational actuation or rotational movement for operating the stove top.

### CROSS-REFERENCE TO RELATED APPLICATIONS

This application is a continuation of PCT/EP2008/001724, filed Mar. 5, 2008, which in turn claims priority to DE 10 2007 014 273.2, filed on Mar. 16, 2007, and DE 10 2007 016 466.3, filed on Mar. 27, 2007, the contents of all of which are incorporated by reference.

### FIELD OF APPLICATION

The invention relates to an operating device for a stove top and to an arrangement of a stove top having such an operating device.

### BACKGROUND

U.S. Patent Publication 2001/008237 discloses an operating device that, for operation, can be mounted to a stove top or set on a stove top plate.

German patent 197 06 169 A1 discloses an operating device that, for operation, can be placed, basically as a separate component, on top of a stove top or on the stove top plate. In the same manner, it can be removed for cleaning purposes or for safety purposes. Here, it is disadvantageous that, due to this, stove top surface is occupied or wasted, as it were. Furthermore, it is disadvantageous that, due to an integrated electronic system, the housing of the operating device must be sealed to allow cleaning, this representing a not to be underestimated effort due to temperature fluctuations in a dish-washing machine and the air in the housing. In addition, the integrated electronic system makes the operating unit significantly more expensive.

### SUMMARY

An object of the invention is to provide a previously mentioned operating device, as well as a previously mentioned arrangement with which the problems of prior art can be avoided, and which, in particular, will be able to provide a favorable arrangement for an operating device with an advantageous and simple functional connection with the stove top.

This object is achieved by an operating device displaying the features and arrangements as claimed herein. Advantageous, as well as preferred, embodiments of the invention are the subject matter of additional claims and will be explained in detail hereinafter.

In accordance with one embodiment of the invention, the operating device comprises a base that is preferably configured in a plate-like or planar manner. This base is designed to be arranged approximately in the plane of the stove top plate or parallel thereto. Advantageously, said base may be arranged next to said stove top plate, for example, on a work surface into which the stove top is partially set, with the stove top plate, usually, resting on the work surface, as it were. Furthermore, at least one operating part is movably supported in the base so that an operation is possible as found in present conventional rotary or sliding knobs. The operating part comprises signal means or is mechanically connected thereto, where the signal means move as the operating parts move, in particular, in exactly in the same manner. The signal means are designed so as to interact with sensor means in the stove top in order to detect a movement of the signal means or, first and foremost, of the operating part. To accomplish this, the sensor means are arranged laterally next to a plane of movement of the signal means or below said plane of movement, advantageously in a plane parallel to the stove top plate, or, optionally opposite the signal means. As a result of this, the signal means—depending on the movement or the position of movement—are always located laterally next to or opposite of the sensor means at a changing distance with respect thereto, or if there is a movement, can be moved either in one direction or the other direction past said sensor means. This results in detecting a movement or position as is known regarding rotation, for example, from the aforementioned DE 197 06 169 A1, however, not only from underneath towards a plane of movement but also from the side, as it were. The operating device is designed in such a manner that it does not comprise an electronic system and thus does not have its own power supply, i.e., it does not have a connection to a power supply network and no power storage. It is possible, as it were, to design it without any electrical functionality, i.e., without any electrically effective components. Alternatively, it may additionally comprise such components, for example, in the form of RFID tags, however, in terms of this application, it may be electrically passive or without any electronic system.

In one basic embodiment of the invention, the operating device is designed for a rotary actuation. To accomplish this, the operating parts are configured as rotary operating parts for the rotary movement in a rotary plane. The sensor means are configured for the detection of a rotation.

In another basic embodiment of the invention, the operating device is designed for a sliding actuation. To accomplish this, the operating parts are configured as sliding operating parts for a sliding movement in a sliding movement plane. The sensor means are configured for a detection of a sliding movement.

Advantageously, not only a single operating part is provided on the base but several, preferably two or four, components are provided. Advantageously, these are configured so as to be the same or identical, as a result of which the manufacturing expenses can be lowered.

In another advantageous embodiment of the invention, the signal means always extends within the base during the movement. Furthermore, it may be advantageously provided that the movement plane of the signal means is approximately in the same plane as the stove top plate or an edge surrounding the stove top plate. Alternatively, the movement plane of the signal means may be parallel to the stove top plate and extend over the stove top plate, i.e., the signal means rotate over the stove top plate. Regarding this, more will be explained in detail hereinafter.

In one embodiment of the invention, it is possible for the operating part to comprise two parts. For this, a removable upper knob may be provided, where said knob can be grasped by hand for movement, i.e., for rotation or a sliding movement. This upper knob may be mounted to a moving part arranged in the base and be rotatably supported. In this arrangement, the signal means are provided on the moving part, in particular close to the outside circumference thereof. Such an arrangement has the advantage that the upper knob may be taken off the lower moving part, for example, for cleaning purposes. Furthermore, the upper knob may be manufactured of special attractive and high grade materials such as aluminium or the like, whereas the lower moving part may be a plastic component, in particular, with the possibility of being able to mount the signal means particularly well thereto.

In an alternative embodiment of the invention, it is possible for the operating part to consist of one part. In this case, a lower region may be arranged or supported in the base and comprise the signal means close to the outside circumference or far toward the outside. An operating part may be supported rigidly or non-removable in the base or it may be removed, for example, for cleaning.

Depending on the type of signal means and sensor means, as well as depending on the type of detection of the movement or movement position, it is possible to provide several signal means per operating part. At least one sensor means is provided in the stove top in order to detect the signal means and their movement or position.

There are different embodiment options for the signal means and the sensor means. One option is an optical detection of a movement or movement position. To accomplish this, the signal means may comprise, for example, lines or a similar distinguishable illustration, or be coded therewith, as is described in a similar manner in EP 1 496 531 A2, for example. The sensor means, which, in this case, may be similar to a barcode reader, are able to recognize the illustration. Such a sensor is configured, first and foremost, for the incremental detection of a representation or a movement of lines or the like.

In a further embodiment of the invention, the signal means may be magnetic or be permanent magnets which are, for example, well embedded in or poured into an operating part of plastic material. The at least one sensor means is then a magnetic field sensor, for example, a Hall sensor, as is also known from the aforementioned prior art.

In yet another alternative embodiment of the invention, the signal means may be configured so as to be capacitive, and the sensor means may be configured for the detection of said signal means. Likewise, it is possible for the signal means to be RFID tags and for the sensor means to be an RFID detection device or an RFID reading station or an RFID base station. Indeed, as explained beforehand, RFID tags may—to a certain extent—also be viewed as electrical components. However, in terms of the present application, they are viewed as being electrically passive.

The operating device may comprise coupling locations for photoconductors or direct light, these being advantageously provided laterally on the base. As a result of this, photoconductors or direct light originating from the stove top may be coupled into the operating device. Thus, an illumination or illuminated display on the operating device is possible, without said device itself requiring any luminescent elements. The coupling locations in the base may be connected with the uncoupling sites on the operating device via photoconductors or the like, where said uncoupling locations may be located, for example, on the upper side of the base. Via additional photoconductor arrangements, it is also possible to introduce light into the operating parts and to illuminate said parts or, for example, provide them with light dots, indicator functions or the like. To do so, it is possible to use light of different colors for different functions.

In the arrangement in accordance with the invention the operating device is mechanically mounted to or next to the stove top and is held magnetically in some situations. Mounting should be such that the device is at least secured against movement in a plane parallel to the stove top plate or the work surface that supports the stove top plate. Preferably, mounting is mechanical, where, in order to accomplish this, the operating device may be fitted on appropriate projections on the stove top edge or the stove top frame. Alternatively, the operating device may have projections on the underside that come into engagement with cut-outs in the stove top edge or in the work surface. Advantageously, the operating device is simply fitted on from above without additional locking means, so that said operating device cannot be shifted or be easily removed again during operation.

In one embodiment of the invention, it is possible to provide the operating device completely next to the stove top or next to the stove top frame such that, in this case, the operating device does not overlap the stove top but abuts laterally or is at a minimal distance. As a result of this, it is possible that, with the exception of the sensor means on the stove top and potentially the photoconductor arrangements, very few design changes need be made to the stove top.

In another embodiment of the invention, the operating device may partially project beyond or overlap or rest on the stove top or the stove top plate, at least at the edge. In this case, the operating part is advantageously located in the base laterally outside the stove top plate, so that said operating part may extend almost down to the work surface or rest thereon, and it is nonetheless ensured that the signal means can move approximately in the plane of the stove top plate or the stove top frame.

In yet another embodiment, the operating part is located in the base above and at least partially on the stove top plate. In this embodiment, the signal means and the sensor means are arranged opposite each other, separated by the stove top plate.

In one embodiment of the operating device laterally next to the stove top, the stove top advantageously has a straight edge. Alternatively, notches or indentations may be provided in the stove top plate or its edge into which the operating device at least partially engages.

Advantageously, the base is open toward the side in the lower region so that the signal means are accessible or visible from the side and, if movement occurs, said signal means move as closely as possible past the stove top or the edge of the stove top. If the signal means and the sensor means are configured for an above-described optical recognition, it is possible to arrange the sensor means directly at the stove top edge. However, alternatively, it is also possible for a remote signal detection to be carried out via a photoconductor arrangement from a location in the stove top edge directly opposite the signal means, in that this photoconductor arrangement may be led to a control with optical sensors placed at any location in the stove top. Thus the arrangement of the sensor means in the stove top edge, which might become very complex, can be avoided.

In many cases, the stove top has two or four cooking locations. In this case, it has been found to be advantageous for one operating device to comprise two operating parts in order to operate two cooking locations of the stove top with them. In this case, it is possible in a particularly advantageous manner, to provide one such dual operating device on the left and one on the right sides at the stove top each, where it is also possible to provide the operating parts in a row on each base to be also approximately consistent with the geometric arrangement of the cooking locations. This makes an intuitive operation of the respectively correct cooking location with the appropriate operating part possible.

In another embodiment of the invention, it is possible to detect whether the operating device has been arranged on the stove top in the prescribed manner in order to achieve clearance for operation of said stove top. To accomplish this, detection means may be provided on the stove top that, in certain situations, may even be formed by the sensor means. In another embodiment of the invention, it may be that the stove top may be operated only when each and every provided operating device has been mounted in accordance with specifications. Thus, this will also permit, for example, a type of child safety.

In yet another embodiment of the invention, one operating device may be used to set each and every function of a stove top that is to be set, such as, power steps, operating times or the like. To accomplish this, it is possible to provide additional on/off switches for functions with the same or a similar sensor system as in the operating part such as, for example, a two-circuit connection. However, in addition, it is also possible to provide additional operating elements on the stove top itself such as, for example, an on/off switch or other switches for additional functions.

A type of detent device may be provided on the operating parts, said devices being used to provide the user with feedback that a setting is taking place in steps. In a simple embodiment, this detent device may be mechanical or a mechanical detent device. In a more complex embodiment, said device may be a magnetic detent device such as is known from the aforementioned DE 197 06 169 A1.

This and additional features are obvious from the claims, as well as from the description and the drawings, where the individual features may be implemented—by themselves or in several forms of sub-combinations—in an embodiment of the invention or in other applications for which protection is claimed here. The division of the application into individual sections as well as the sub-headings do not restrict the general validity of the statements presented thereunder.

### BRIEF DESCRIPTION OF THE DRAWINGS

Exemplary embodiments of the invention are schematically shown in the drawings and will be explained in detail hereinafter.

FIG. 1 illustrates a plan view of an arrangement of a stove top with a laterally mounted operating device that comprises a rotary operating part;

FIG. 2 illustrates a section through the arrangement of FIG. 1;

FIG. 3 illustrates an oblique view of an alternative arrangement of a stove top with operating devices mounted to the left and right, respectively, each of said devices comprising two rotary operating parts;

FIG. 4 illustrates a schematic section through an arrangement in accordance with FIG. 3;

FIG. 5 illustrates a view of the underside of the rotary operating part of FIG. 4;

FIG. 6 illustrates an alternative embodiment of a rotary operating part with decreasing outside radius; and

FIG. 7 illustrates a view, similar to that of FIG. 6, of an operating device comprising a sliding operating part.

### DETAILED DESCRIPTION OF THE EXEMPLARY EMBODIMENTS

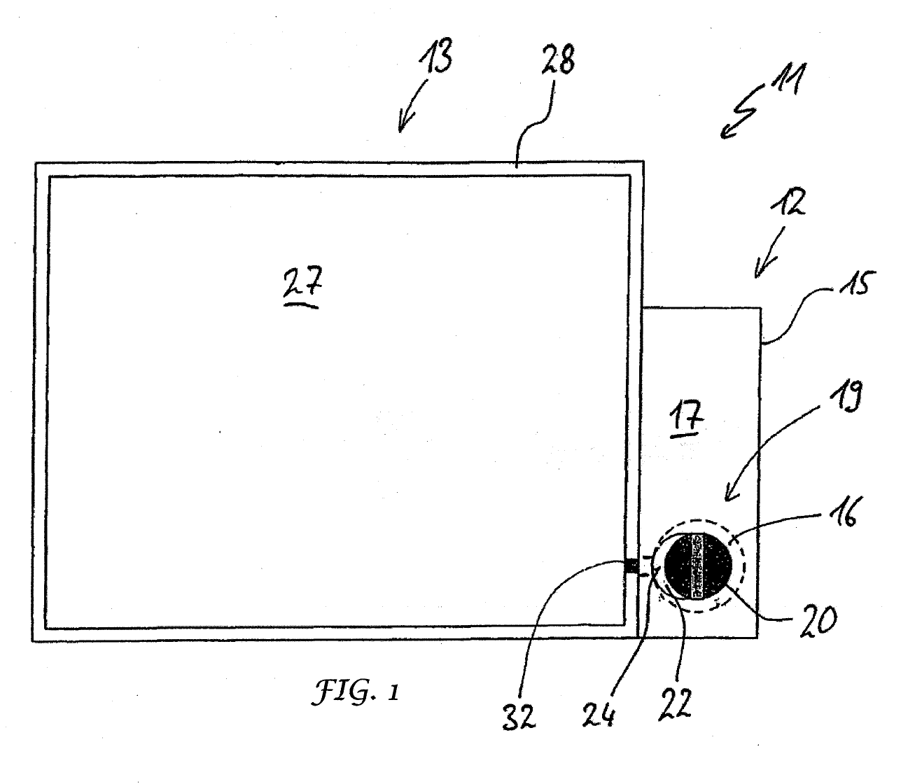

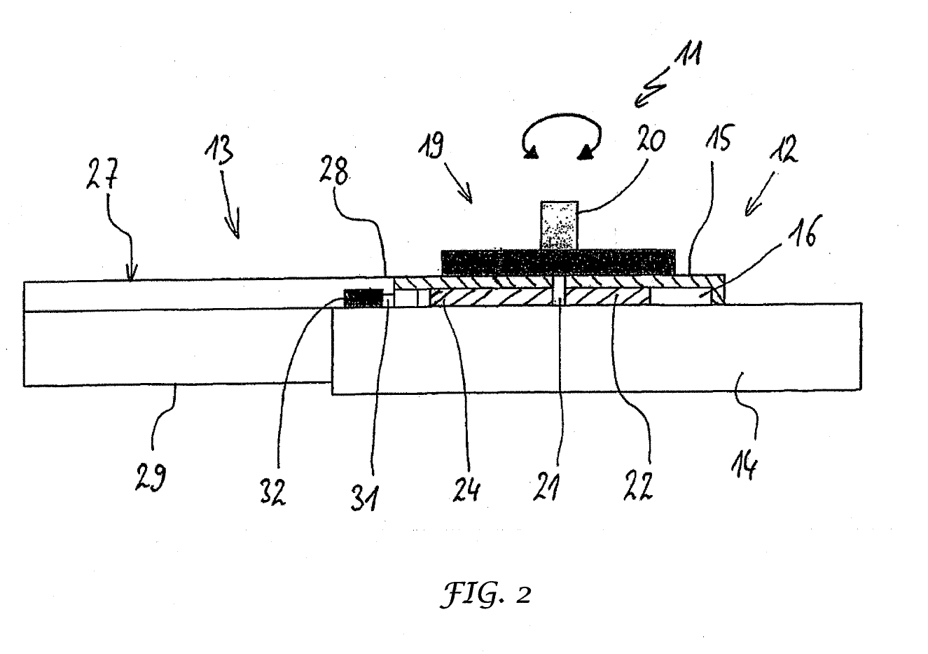

FIG. 1 is a plan view of an arrangement 11 in accordance with the invention, said arrangement comprising an operating device 12 that is mounted laterally to the right of a stove top 13. This arrangement 11 is also shown by the sectional view of FIG. 2. The operating device 12 comprises a plate-like base 15 that is set on a work surface 14 in which the stove top 13 is placed and fixed. The plate-like base 15 has an essentially closed upper side 17, whereas it has a circular cut-out 16 on the underside as indicated in shaded lines in FIG. 1. A rotary operating part 19 is provided in the region of this cut-out 16. The rotary operating part 19 comprises a rotary knob 20 resting on the base 15 or its upper side 17, said knob being easy to grip and turn, where a detent means that is not specifically illustrated may be provided for the rotary movement. Via a rotary axle 21, the rotary knob 20 is connected with a disk-like rotary part 22 in the manner of an eccentric rotary part or a cam, the rotary axle 21 being supported in an appropriate opening through the base 15 providing a rotary support. The height of the cut-out and the thickness of the rotary part 22 are dimensioned so as to achieve easy movability, and that, for example, the underside of the rotary part 22 does not drag or rub against the upper side of the work surface 14.

The stove top 13 has a stove top plate 27 that, advantageously, is glass ceramic. Said plate is held in or enclosed by a peripheral edge 28. The functional units are closed by means of a cover 29 in downward direction. The peripheral edge 28 may be a metal profile, for example, of stainless steel or aluminium.

As is obvious from the plan view in FIG. 1, the rotary part 22 is eccentric, i.e., it projects clearly to the left over the surface of the rotary knob 20. The rotary part 22 may also be a circular disc having a smaller diameter than the cut-out 16, the rotary axle 21 being mounted therein off-center or concentrically. The region 24 that projects the most beyond the surface of the rotary knob 20 or that is the farthest from the rotary axle 21 extends the farthest toward the left of the stove top 13. If the rotary operating part is rotated, the projecting region 24 rotates about the rotary axle 21, i.e., always just barely on the internal edge of the cut-out 16.

At the point closest to the rotary operating part 19, the edge 28 has, on its underside, a recess 31 in which an optical distance sensor 32 is arranged as the sensor means. As a result of an optical distance measurement, the rotary or angular position of the rotary operating part 19 is determined. As is obvious, in particular, from the plan view of FIG. 1, a certain distance exists between the projecting region 24 and the distance sensor 32, said distance changing with rotation. The distance sensor 32 is connected with a control of the stove top 14 in a not illustrated manner in order to evaluate the signals and to determine the rotary movement of the rotary operating part 19 in this stove top control. Inasmuch as the cut-out 16 or the base 15 is open toward the left in a narrow region, as is obvious from FIG. 2, and also the recess 31 below the edge 28 is open toward the right, a reliable detection is possible. An inductive proximity sensor can also be used as the sensor means when the rotary part 22 consists of a metal-like or metallic material. As an alternative to the illustrated optical distance sensor 32, it is also possible to provide capacitive signal means and corresponding sensor means.

Another advantageous option is to mount several RFID tags on the circumference of a rotary part 22, and install an RFID base station or reading station as the sensor means. The RFID tags are configured in such a manner that they can be read only when they are at a small distance from the RFID reading station. Each of the RFID tags bears a different code. Thus, the rotary position can be unambiguously determined because only one RFID tag can be read at one time. If it is possible to read two RFID tags, the rotary part is in an intermediate position. In such an embodiment, it is another advantage that not only a rotation but also a rotary position can be detected, so that the position of the rotary part can also be instantly and unambiguously determined after a power failure.

Yet another option is to provide an optical detection of the rotation or rotary position. To do so, codes instead of magnets 24 may be provided on the outside edge of the rotary part 22, said codes being lines, for example, that have different widths and distances from each other, as is basically known from DE 10330912 A1. In this case, the sensor means 32 are configured as an optical scanning or detection device that detects line patterns, in particular. In a preferred embodiment, a barcode—similar to a very simple barcode—may represent a number in a simple line pattern per position of the rotary part 22, where, for example, seven to twelve positions may be provided. This number that is represented, for example, by three to five lines indicates the position and thus, for example, a power step. The positions may be prespecified by the aforementioned mechanical detent arrangement.

In yet another embodiment of the invention, it is possible to close the base 15 on the underside, in particular in the region of the cut-out 16. In this manner a soiling of the cut-out 16 and thus a resultant difficult rotary movement can be prevented. The rotary operating part may be designed so as to consist of one piece and be installed from the bottom through an appropriately large opening in a cut-out in the base and project beyond the upper side for rotation; or the entire cut-out 16 could be open toward the top and an operating part could be set in from the top, said operating part having a diameter that may be larger than the cut-out and thus be able to cover said cut-out.

In another embodiment of the invention, it may be possible to insert light signals via a photoconductor arrangement from inside the stove top into corresponding coupling sites on the operating device and to generate visible signals or light displays on the upper side 17, i.e., similarly as in the arrangement of the sensor means 32 and signal means 24 as in FIG. 2.

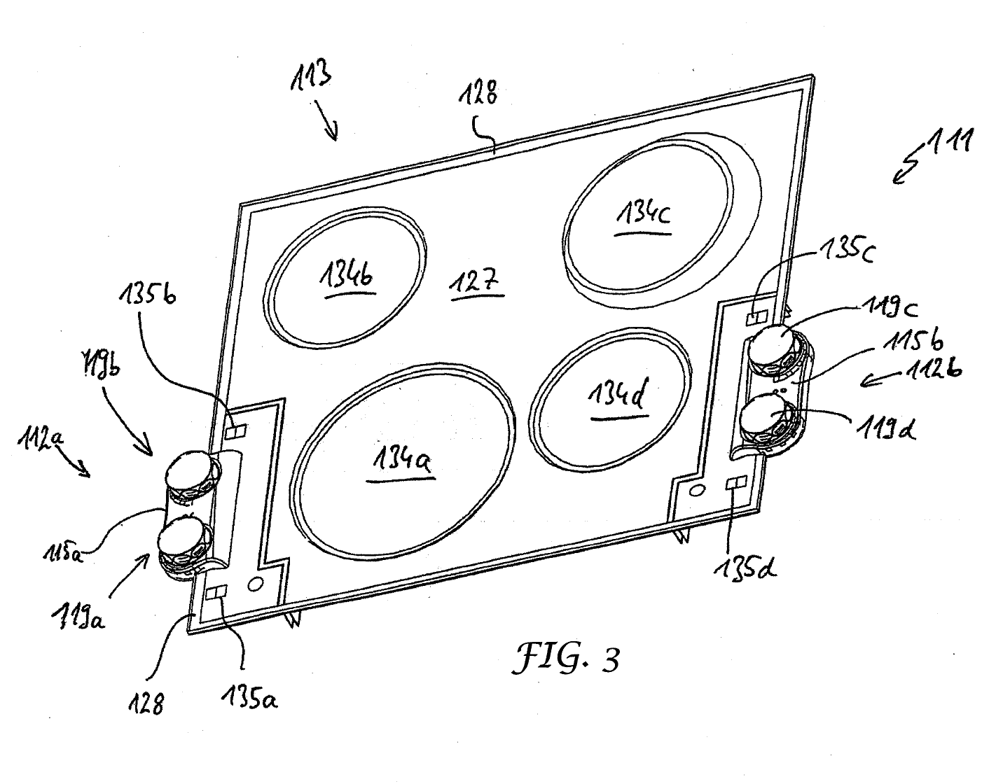

FIG. 3 shows a modified arrangement 111. In this case, a stove top 112 comprises four cooking locations 134a-d, as is known per se. Mounted on the left on a peripheral edge 128 of the cooking location 113 is a first left operating device 112a, and on the right is a second right operating device 112b. The operating devices 112a and 112b have a base 115a and 115b, respectively, as well as rotary operating parts 119a-d. Principally, the configuration of the operating devices 112a and 112b may be similar to those depicted in FIGS. 1 and 2 and described above. However, different therefrom, the base 115a and 115b, respectively, overlaps the upper side of the stove top plate 127 slightly. This means that the rotary operating parts 119 partially extend above the stove top plate 117. The lower rotary parts extending in the base 115a and 115b, respectively, said parts not being illustrated here, may have a diameter that is small enough that they do not contact or break through the edge 128 of the stove top plate 127, said edge 128 continuing in a straight line. Advantageously, said rotary parts even extend outside the edge of the 128 stove top. They may be configured as described regarding FIGS. 1 and 2. Alternatively, the detection of the rotary movement may be configured in accordance with one of the above-described options.

As in the case of the arrangement 11 or the operating device 12 of FIGS. 1 and 2, the embodiment in accordance with FIG. 3 does not have operating parts 112a and 112b with so-called intelligence. Advantageously, there are not even devices that require electrical power. It is thus very easily possible to remove the operating devices from the stove top or from a work surface into which the stove top has been sunken, for example, for simple cleaning in the dish-washing machine or also as a child-safety feature.

It is obvious how, in mounted state, displays 135a-d are provided, respectively, next to the rotary operating parts 119a-d, said displays being seven-segment displays. Each of them is able to display the output or another function of a cooking location 134 allocated to the respective rotary operating part 119. Additional operating elements which can be used, for example to switch the stove top on or off, are not shown.

Considering the invention, it is particularly advantageous, as is also shown by FIG. 2, that an operating device may be attached outside a stove top and does not restrict the latter's available cooking locations. Furthermore, the operating devices are constructed in a very simple manner and do not require their own power supply and not even a power supply via electrical contacts or the like. Mounting or removing of an operating device may be considered as switching the stove top on or off.

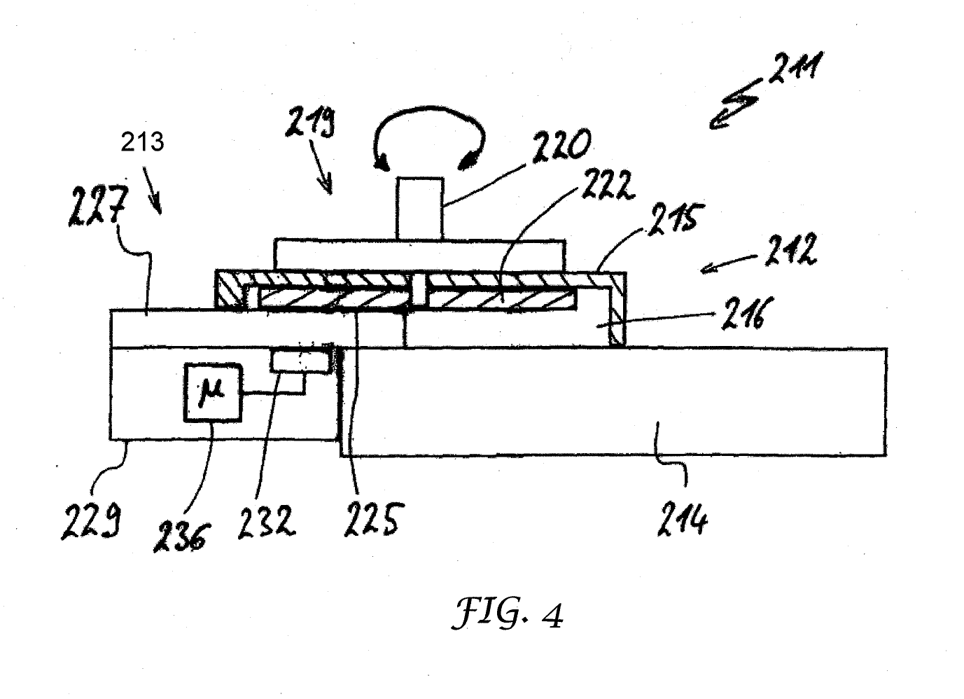

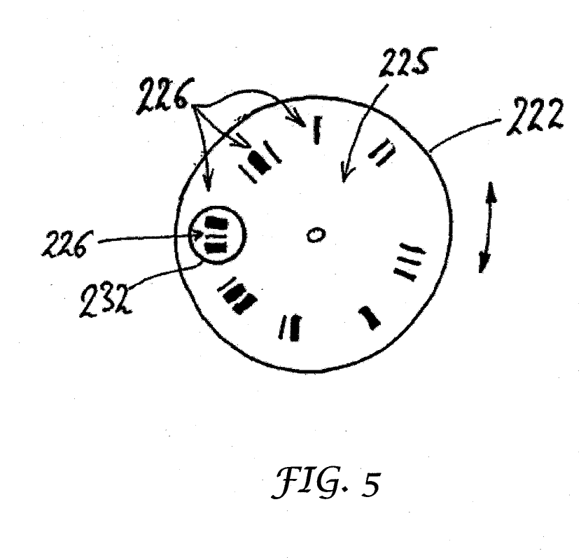

FIG. 4 shows a modification of FIG. 3, namely, an operating device 212 that, indeed, also extends partially above a stove top plate 217. However, also in this case, a rotary part 222 extends above the stove top plate 217. The rotary part 217 comprises, on its underside, a code for the detection of the rotary position that is shown, in detail, in FIG. 5. Below the stove top plate 217, is an optical sensor 232 that is configured for the detection of the code, i.e., through the stove top plate 217. For evaluation, said sensor is connected with a control 236 that may represent the stove top control.

FIG. 5 shows how eight different symbols or line patterns 226 form the code. These line patterns 226 consist of three to five lines—alternately white and black—which may have different thicknesses. Each line pattern 226 characterizes a rotary position of the rotary operating part 219. Additional combinations of lines for more line patterns and thus for more rotary positions are conceivable. A precise holding of the rotary part 222 in such a manner that a line pattern 226 comes to be located somewhat exactly over the sensor 232 for potential detection can be achieved by a not illustrated detent device, for example on the rotary axle 221 or laterally outside on the lateral edge of the rotary part 222. The implementation of such a detent device is generally known to the person skilled in the art. However, such a device need not be present.

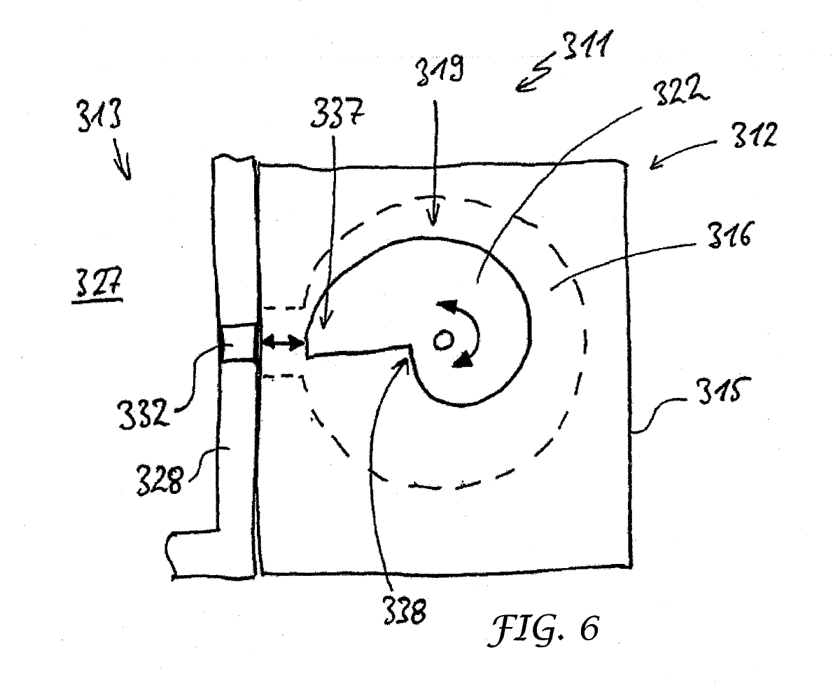

FIG. 6 is a plan view, considering an additional arrangement similar to that of FIG. 1, depicting how a rotary part 322 can be rotatably supported on a rotary axle 321 in a cut-out 316 of a base 315. On its outside edge, this rotary part is configured in the manner of a spiral over one rotation having a largest radius 337 that steadily decreases toward a smallest radius 338. Similar to FIGS. 1 and 2, an optical distance sensor 332 is used to measure the distance from the outside edge, and the rotary position is determined based on this. Different from FIG. 2, each rotary position is accurately and unambiguously determined and detectable across this distance.

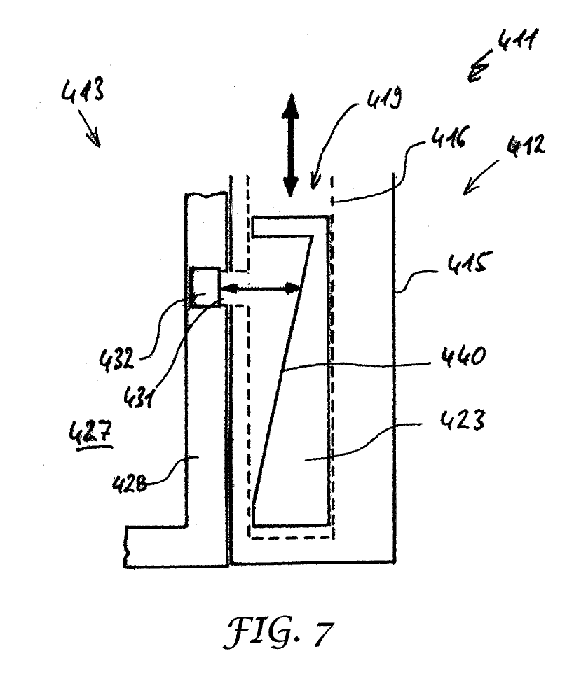

FIG. 7 shows, as another embodiment of the invention, the rotary principle of rotation of the previous examples converted into a linear operating principle with a sliding part 423. The sliding part 423 extends in a longitudinal cut-out 416 representing a type of sliding link that is provided in a base 415. A stove top 413 is configured similar to that shown in FIG. 1 and comprises an edge 428 in which an optical distance sensor 432 is arranged behind a recess 431. The sliding part 423 has a side 440 that is slanted relative to the distance sensor, the sliding part 423 displaying a continuously changing width. If, now, the sliding part 423 is moved in the cut-out 416 corresponding to the arrow of movement, the changing distance relative to the distance sensor 432 permits the detection of a sliding position that may be linked with different commands like the rotary position of the other examples. In this manner, the rotary principle of FIGS. 1 through 6 may be implemented with a translatory operating movement. In a similar manner, this may also be implemented with codes or line patterns for optical detection that are provided on the side, or also with other signal means as in the other examples.

1. An operating device for a stove top, said stove top including a stove top plate, said operating device comprising:
a base arranged in a plane of said stove top plate or parallel thereto;
at least one operating part being movably supported in said base, whereby said operating part comprises or is connected with signal means that move corresponding to a movement of said operating part, said signal means configured so as to interact with sensor means in said stove top for detection of a movement of said operating part, whereby said operating device is configured so as to comprise passive electronic components and is thus configured to function without its own power supply.

2. The operating device according to claim 1, wherein said operating part is a rotary operating part being supported in said base so as to be rotatable, whereby said signal means rotate correspondingly with a rotation of said rotary operating part, said signal means being configured so as to interact with sensor means in said stove top for detection of said rotary movement.

3. The operating device according to claim 1, wherein said operating part is a sliding operating part being supported in said base so as to be movable in a sliding manner, whereby said signal means move correspondingly with a sliding movement of said sliding operating part, said signal means configured so as to interact with sensor means in said stove top for detection of said sliding movement.

4. The operating device according to claim 1, wherein said base comprises two or more operating parts.

5. The operating device according to claim 1, wherein said base is flat and has a plate-like configuration.

6. The operating device according to claim 1, wherein a plane of said path of movement of said signal means is parallel to said stove top plate and is located approximately in a same plane, said sensor means being arranged in a plane of movement of said signal means laterally adjacent thereto, wherein said plane of movement is located inside said base.

7. The operating device according to claim 1, wherein said plane of movement of said signal means is parallel to said stove top plate and extends over said stove top plate.

8. The operating device according to claim 1, wherein said operating part comprises two pieces comprising a removable upper knob and a lower moving part arranged in said base so as to be rotatably supported, wherein said signal means are arranged on a side or outside said moving part.

9. The operating device according to claim 1, wherein said operating part consists of one piece and comprises, in a lower region that is located completely inside said base, said signal means on a side or outside.

10. The operating device according to claim 1, wherein said operating part comprises several signal means and said operating part is associated with at least one sensor means in said stove top.

11. The operating device according to claim 1, wherein said signal means and said sensor means are configured for an optical detection of a movement position or a movement of said operating part.

12. The operating device according to claim 11, wherein said signal means are coded with distinguishable visual indicia representation and wherein said sensor means are configured for a detection of said distinguishable visual indicia.

13. The operating device according to claim 1, wherein said signal means and said sensor means are configured for an optical detection of a movement position or a movement of said operating part by detecting a changing distance of said operating part from said sensor means, said signal means associated with a changing radius or a changing width of said operating part, and said sensor means configured for allowing detection of said distance from said operating part.

14. The operating device according to claim 1, wherein said signal means are magnetic or are permanent magnets, and said sensor means are magnetic field sensors.

15. The operating device a according to claim 1, wherein said signal means are configured so as to be capacitive, and said sensor means are configured for a capacitive detection.

16. An arrangement of a stove top comprising an operating device according to claim 1, wherein said operating device is mechanically fixed on or next to said stove top, at least against movements in a plane parallel to said stove top plate, wherein said operating device is configured so that it is attachable perpendicular to said plane parallel to said stove top plate.

17. An arrangement according to claim 16, wherein said operating device is arranged, without overlapping said stove top or said stove top plate, laterally next to said stove top.

18. An arrangement according to claim 16, wherein said operating device projects at least partially over, overlaps or rests on said stove top or said stove top plate, wherein said operating part is located essentially laterally outside said stove top plate.

19. An arrangement according to claim 16, wherein said base is open toward a side in a lower region in such a manner that said signal means of said operating part are laterally openly accessible or visible and move closely past said stove top or past an edge of said stove top, wherein said sensor means are provided at said stove top in said region at smallest distance from said signal means relative to said stove top, wherein said signals means or said sensor means are configured for an optical detection, and whereby said sensor means are arranged inside said stove top remote from said operating device and are connected, by means of photoconductors, with a region at said stove top that is close to said signal means.

20. An arrangement according to claim 16, wherein an operating device comprises two operating parts for operation of two cooking locations of said stove top, wherein said stove top has four cooking locations and two operating devices with two operating parts, respectively one operating device on a left side and one operating device on a right side of said stove top.

21. An arrangement according to claim 16, wherein said stove top comprises, in addition to an operating device in accordance with claim 1, additional operating elements for functions of said stove top.

22. An arrangement according to claim 16, wherein additional operating elements are provided on said base for a two-circuit function or an initial cooking surge or an on/off switch, wherein said additional operating elements are optical operating elements or are configured for a detection with an optical sensor system.
